(19) United States
(12) Patent Application Publication
(10) Pub. No.: US 2017/0314233 A1
(43) Pub. Date: Nov. 2, 2017

(54) CONTROL SYSTEM OF HYBRID CONSTRUCTION MACHINE

(71) Applicant: KYB Corporation, Tokyo (JP)

(72) Inventors: Masahiro EGAWA, Saitama (JP); Haruhiko KAWASAKI, Kanagawa (JP); Yasuhiro YONEHARA, Kanagawa (JP); Masayuki KOBAYASHI, Tokyo (JP)

(73) Assignee: KYB Corporation, Tokyo (JP)

(21) Appl. No.: 15/518,265

(22) PCT Filed: Jul. 22, 2015
(86) PCT No.: PCT/JP2015/070825

§ 371 Date: Apr. 11, 2017

(30) Foreign Application Priority Data
Nov. 25, 2014 (JP) 2014-237328

(51) Int. Cl. E02F 9/20; F15B 21/14; F15B 11/02; E02F 9/22; H02K 7/18

(52) U.S. Cl. CPC E02F 9/2091; H02K 7/1807; F15B 21/14; F15B 11/02; E02F 9/2217; E02F 9/2292; E02F 9/2271; E02F 9/2239; E02F 9/2296

(57) ABSTRACT

A control system of a hybrid construction machine includes fluid pressure pumps, a regeneration motor, a rotating electric motor coupled to the regeneration motor, a storage battery configured to store electric power generated by the rotating electric motor, an assist pump provided coaxially to the regeneration motor to be driven by the rotating electric motor, the assist pump being configured to supply a working fluid to a fluid pressure actuator, and load adjusting units configured to change a load of the assist pump in accordance with a state of the storage battery.

### TECHNICAL FIELD

The present invention relates to a control system of a hybrid construction machine.

### BACKGROUND ART

JP2012-154092A discloses a hybrid construction machine in which an electric motor to be driven by electric power of a storage battery and an engine are used in combination as a power source. In this hybrid construction machine, the storage battery is heated by circulating cooling water heated by heat of the engine in a case where a temperature of the storage battery is lower than a lower limit value of a proper temperature, and the storage battery is cooled by circulating cooling water cooled by a radiator in a case where the temperature of the storage battery is higher than an upper limit value of the proper temperature.

### SUMMARY OF INVENTION

However, the hybrid construction machine described in JP2012-154092A cannot be used before a state of the storage battery becomes a proper state. Therefore, particularly at the time of initial start-up in a low temperature region, there is a need for heating the storage battery for a long time. Thus, there is a fear that an energy loss is increased and workability is lowered.

An object of the present invention is to provide a control system of a hybrid construction machine capable of performing a normal operation irrespective of a state of a storage battery.

According to one aspect of the present invention, a control system of a hybrid construction machine includes a fluid pressure pump configured to supply a working fluid to a fluid pressure actuator, a regeneration motor configured to be rotated by the working fluid discharged from a load side pressure chamber of the fluid pressure actuator, a rotating electric motor coupled to the regeneration motor, a storage battery configured to store electric power generated by the rotating electric motor, an assist pump provided coaxially to the regeneration motor to be driven by the rotating electric motor, the assist pump being configured to supply the working fluid to the fluid pressure actuator, and a load adjusting unit configured to change a load of the assist pump in accordance with a state of the storage battery.

### BRIEF DESCRIPTION OF DRAWINGS

FIG. 1 is a circuit diagram showing a control system of a hybrid construction machine according to an embodiment of the present invention.

FIG. 2 is a diagram showing an example of a map of a battery temperature coefficient with respect to a temperature of a battery.

FIG. 3 is a diagram showing an example of a map of a charge coefficient with respect to a SOC of the battery.

FIG. 4 is a circuit diagram showing a control system of a hybrid construction machine according to a modified example of the embodiment of the present invention.

### DESCRIPTION OF EMBODIMENTS

Hereinafter, an embodiment of the present invention will be described with reference to the drawings.

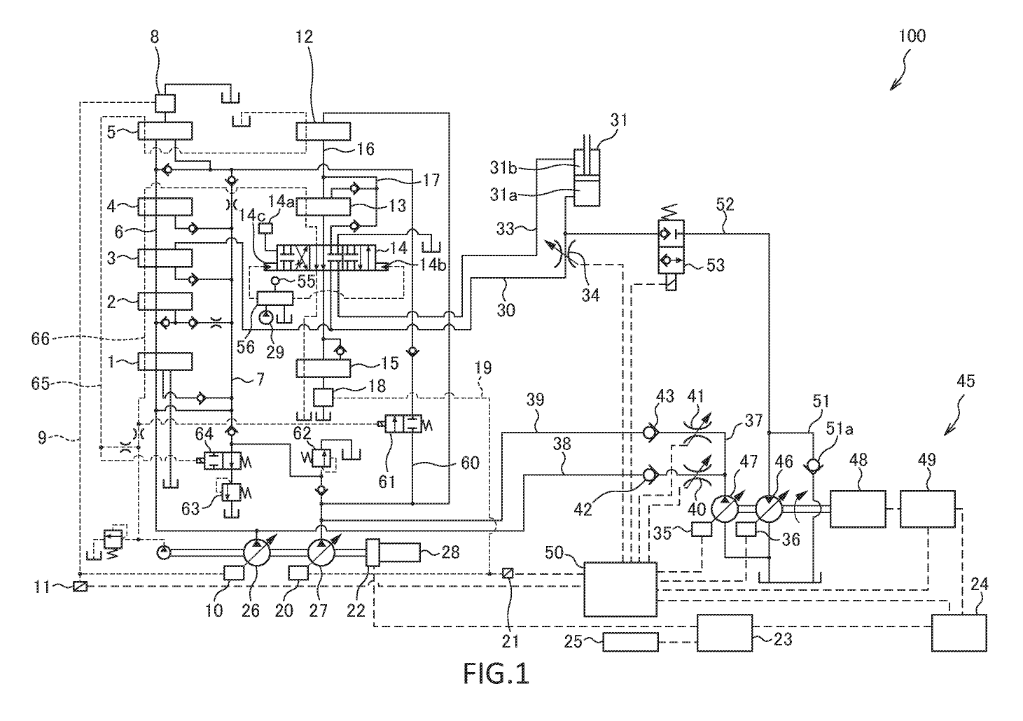

Firstly, with reference to FIGS. 1 to 3, a control system 100 of a hybrid construction machine according to the embodiment of the present invention will be described. In the present embodiment, a case where the hybrid construction machine is a hydraulic excavator will be described. In the hydraulic excavator, working oil is used as a working fluid.

As shown in FIG. 1, the hydraulic excavator includes first and second main pumps 26 and 27 serving as fluid pressure pumps. Each of the first and second main pumps 26 and 27 is a variable capacity type pump in which a tilting angle of a swash plate can be adjusted. The first and second main pumps 26 and 27 are driven by an engine 28 and coaxially rotated.

The working oil discharged from the first main pump 26 is supplied to an operation valve 1 configured to control a turning motor (not shown), an operation valve 2 for arm first gear configured to control an arm cylinder (not shown), an operation valve 3 for boom second gear configured to control a boom cylinder (not shown), an operation valve 4 configured to control auxiliary attachment (not shown), and an operation valve 5 configured to control a left-hand side first traveling motor (not shown) in order from the upstream side. The turning motor, the arm cylinder, the boom cylinder, and a hydraulic device connected to the auxiliary attachment, and the first traveling motor correspond to fluid pressure actuators (hereinafter, simply referred to as the “actuators”).

The operation valves 1 to 5 control flow rates of the working oil guided from the first main pump 26 to the actuators and control actions of the actuators. The operation valves 1 to 5 are operated by pilot pressure supplied in accordance with an operator of the hydraulic excavator manually operating an operation lever.

The operation valves 1 to 5 are connected to the first main pump 26 through a neutral passage 6 and a parallel passage 7 serving as main passages parallel to each other. On the downstream side of the operation valve 5 in the neutral passage 6, a pilot pressure generation mechanism 8 for generating the pilot pressure is provided. The pilot pressure generation mechanism 8 generates high pilot pressure on the upstream side when a flow rate of the passing working oil is high, and generates low pilot pressure on the upstream side when the flow rate of the passing working oil is low.

In a case where all the operation valves 1 to 5 are placed at neutral positions or in the vicinity of the neutral positions, the neutral passage 6 guides all or part of the working oil discharged from the first main pump 26 to a tank. In this case, since the flow rate of the working oil passing through the pilot pressure generation mechanism 8 is increased, high pilot pressure is generated.

Meanwhile, when the operation valves 1 to 5 are switched to full stroke, the neutral passage 6 is closed and no working oil is distributed. In this case, the flow rate of the working oil passing through the pilot pressure generation mechanism 8 is almost eliminated, and the pilot pressure is maintained to be zero. However, depending on operation amounts of the operation valves 1 to 5, part of the working oil discharged from the first main pump 26 is guided to the actuators, and the remaining working oil is guided to the tank from the neutral passage 6. Therefore, the pilot pressure generation mechanism 8 generates the pilot pressure according to the flow rate of the working oil of the neutral passage 6. That is, the pilot pressure generation mechanism 8 generates the pilot pressure according to the operation amounts of the operation valves 1 to 5.

A pilot passage 9 is connected to the pilot pressure generation mechanism 8. The pilot pressure generated in the pilot pressure generation mechanism 8 is guided to the pilot passage 9. The pilot passage 9 is connected to a regulator 10 configured to control a discharge capacity (tilting angle of the swash plate) of the first main pump 26.

The regulator 10 controls the tilting angle of the swash plate of the first main pump 26 in proportion to the pilot pressure of the pilot passage 9 (a proportional constant takes a negative number). Thereby, the regulator 10 controls a pushing amount per one rotation of the first main pump 26. Therefore, when the operation valves 1 to 5 are switched to full stroke, a flow of the neutral passage 6 is eliminated, and the pilot pressure of the pilot passage 9 becomes zero, which makes the tilting angle of the first main pump 26 maximized. At this time, the pushing amount per one rotation of the first main pump 26 is maximized.

A first pressure sensor 11 configured to detect the pressure of the pilot passage 9 is provided in the pilot passage 9. A pressure signal detected by the first pressure sensor 11 is outputted to a controller 50 to be described later.

The working oil discharged from the second main pump 27 is supplied to an operation valve 12 configured to control a right-hand side second traveling motor (not shown), an operation valve 13 configured to control a bucket cylinder (not shown), an operation valve 14 for boom first gear configured to control a boom cylinder 31, and an operation valve 15 for arm second gear configured to control the arm cylinder (not shown) in order from the upstream side. The second traveling motor, the bucket cylinder, the boom cylinder 31, and the arm cylinder correspond to fluid pressure actuators (hereinafter, simply referred to as the “actuators”).

The operation valves 12 to 15 control flow rates of the working oil guided from the second main pump 27 to the actuators and control actions of the actuators. The operation valves 12 to 15 are operated by pilot pressure supplied in accordance with the operator of the hydraulic excavator manually operating the operation lever.

The operation valves 12 to 15 are connected to the second main pump 27 through a neutral passage 16. The operation valve 13 and the operation valve 14 are connected to the second main pump 27 through a parallel passage 17 parallel to the neutral passage 16. On the downstream side of the operation valve 15 in the neutral passage 16, a pilot pressure generation mechanism 18 for generating the pilot pressure is provided. The pilot pressure generation mechanism 18 has the same function as the pilot pressure generation mechanism 8 on the side of the first main pump 26.

A pilot passage 19 is connected to the pilot pressure generation mechanism 18. The pilot pressure generated in the pilot pressure generation mechanism 18 is guided to the pilot passage 19. The pilot passage 19 is connected to a regulator 20 configured to control a discharge capacity (tilting angle of the swash plate) of the second main pump 27.

The regulator 20 controls the tilting angle of the swash plate of the second main pump 27 in proportion to the pilot pressure of the pilot passage 19 (a proportional constant takes a negative number). Thereby, the regulator 20 controls a pushing amount per one rotation of the second main pump 27. Therefore, when the operation valves 12 to 15 are switched to full stroke, a flow of the neutral passage 16 is eliminated, and the pilot pressure of the pilot passage 19 becomes zero, which makes the tilting angle of the second main pump 27 maximized. At this time, the pushing amount per one rotation of the second main pump 27 is maximized.

A second pressure sensor 21 configured to detect the pressure of the pilot passage 19 is provided in the pilot passage 19. A pressure signal detected by the second pressure sensor 21 is outputted to the controller 50 to be described later.

On the downstream of the first and second main pumps 26, 27 in the neutral passages 6 and 16, a first main relief valve 62 configured to relieve pressure of the working oil when the pressure exceeds preliminarily set predetermined main relief pressure, a second main relief valve 63 whose relief pressure is set to be lower than the first main relief valve 62, and a switching valve 64 capable of connecting the neutral passages 6 and 16 to the second main relief valve 63 are provided. The predetermined main relief pressure is set to be so high that the lowest working pressure of the actuators can be sufficiently ensured.

The first main relief valve 62 always communicates with the neutral passages 6 and 16. The second main relief valve 63 communicates with the neutral passages 6 and 16 in a case where the switching valve 64 is switched to an opened state. Thereby, when the switching valve 64 is switched to an opened state, the relief pressure of the neutral passages 6 and 16 is lowered in comparison to a case of a closed state.

A switching valve 61 serving as a switching valve for straight traveling is provided in a distribution passage 60 branching from the neutral passage 16. When the operation valve 5 configured to control the action of the first traveling motor and the operation valve 12 configured to control the action of the second traveling motor are switched to positions to move in the same direction, pressure of a pilot passage 65 is boosted. At the same time, when at least one of the operation valves 1 to 4 and 13 to 15 is switched to activate the actuator, pressure of a pilot passage 66 is boosted. Thereby, the switching valve 61 is switched to an opened state by the pilot pressure.

When the switching valve 61 is switched to an opened state, the working oil discharged from the second main pump 27 is supplied to the first traveling motor and the second traveling motor via the operation valve 5 and the operation valve 12 at the same flow rate. Thereby, in the hydraulic excavator, even when the operator intends to let the hydraulic excavator travel straight on but other actuators are actuated, the first traveling motor and the second traveling motor are rotated at the same speed without receiving any influence of said other actuators. Therefore, the hydraulic excavator can travel straight on.

A power generator 22 configured to generate electric power by utilizing remaining power of the engine 28 is provided in the engine 28. The electric power generated in the power generator 22 is charged in a battery 24 via a battery charger 23. The battery charger 23 can charge the electric power in the battery 24 even in a case where the battery charger is connected to a normal household power source 25.

In the battery 24, a temperature sensor (not shown) serving as a temperature detector configured to detect a temperature of the battery 24, a voltage sensor (not shown) serving as a voltage detector configured to detect voltage of the battery 24, and a SOC calculation unit (not shown) configured to calculate a SOC (State of Charge) from the detected temperature and the detected voltage are provided. The temperature sensor, the voltage sensor, and the SOC calculation unit output electric signals in accordance with the detected values to the controller 50 to be described later. The temperature and the SOC of the battery 24 correspond to a state of a storage battery.

It should be noted that instead of the configuration in which the temperature sensor, the voltage sensor, and the SOC calculation unit are provided in the battery 24, for example, the temperature sensor and the voltage sensor may be attached to an external part of the battery 24, and the SOC calculation unit may be provided in the controller 50.

Next, the boom cylinder 31 will be described.

The operation valve 14 configured to control the action of the boom cylinder 31 is a three-position switching valve. The operation valve 14 is operated by the pilot pressure supplied from a pilot pump 29 to pilot chambers 14b and 14c through a pilot valve 56 in accordance with the operator of the hydraulic excavator manually operating an operation lever 55. The operation valve 3 for boom second gear is switched in conjunction with the operation valve 14 in a case where an operation amount of the operation lever 55 by the operator is more than a predetermined amount.

In a case where the pilot pressure is supplied to the pilot chamber 14b, the operation valve 14 is switched to an extended position (right side position in FIG. 1). When the operation valve 14 is switched to the extended position, the working oil discharged from the second main pump 27 is supplied to a piston side chamber 31a of the boom cylinder 31 through a supply and discharge passage 30, and the return working oil from a rod side chamber 31b is discharged to the tank through a supply and discharge passage 33. Therefore, the boom cylinder 31 is extended and a boom is lifted.

Meanwhile, in a case where the pilot pressure is supplied to the pilot chamber 14c, the operation valve 14 is switched to a stowed position (left side position in FIG. 1). When the operation valve 14 is switched to the stowed position, the working oil discharged from the second main pump 27 is supplied to the rod side chamber 31b of the boom cylinder 31 through the supply and discharge passage 33, and the return working oil from the piston side chamber 31a is discharged to the tank through the supply and discharge passage 30. Therefore, the boom cylinder 31 is stowed and the boom is lowered.

In a case where the pilot pressure is not supplied to both the pilot chambers 14b and 14c, the operation valve 14 is switched to a neutral position (state shown in FIG. 1). When the operation valve 14 is switched to the neutral position, supply and discharge of the working oil to and from the boom cylinder 31 are blocked, and the boom is maintained in a stopped state.

In a case where the operation valve 14 is switched to the neutral position and movement of the boom is stopped, force in the stowing direction acts on the boom cylinder 31 by self-weight of a bucket, an arm, the boom, and the like. In such a way, the boom cylinder 31 maintains a load by the piston side chamber 31a in a case where the operation valve 14 is placed at the neutral position. Therefore, the piston side chamber 31a corresponds to a load side pressure chamber.

The control system 100 of the hybrid construction machine includes a regeneration unit 45 configured to collect energy of the working oil from the boom cylinder 31 and perform energy regeneration. Hereinafter, the regeneration unit 45 will be described.

The regeneration unit 45 has a regeneration motor 46 for regeneration to be rotated by the working oil discharged from the piston side chamber 31a of the boom cylinder 31, an electric motor 48 serving as a rotating electric motor/power generator coupled to the regeneration motor 46, an inverter 49 configured to convert electric power generated by the electric motor 48 into a direct current, and the battery 24 serving as the storage battery configured to store the electric power generated by the electric motor 48.

Regeneration control by the regeneration unit 45 is executed by the controller 50. The controller 50 includes a CPU (central processing unit) configured to execute the regeneration control, a ROM (read only memory) in which a control program, setting values, and the like required for processing actions of the CPU are stored, and a RAM (random access memory) configured to temporarily store information detected by various sensors.

The regeneration motor 46 is a variable capacity type motor in which a tilting angle can be adjusted and being coupled to be rotated coaxially to the electric motor 48. The regeneration motor 46 can drive the electric motor 48. In a case where the electric motor 48 functions as a power generator, the electric power generated by the electric motor 48 is charged in the battery 24 via the inverter 49. The regeneration motor 46 and the electric motor 48 may be directly coupled or may be coupled via a reducer.

On the upstream of the regeneration motor 46, a pump-up passage 51 is connected, through which the working oil is pumped up from the tank to a regeneration passage 52 to be described later and supplied to the regeneration motor 46 in a case were an amount of supplying the working oil to the regeneration motor 46 becomes insufficient. In the pump-up passage 51, a check valve 51a configured to allow only a flow of the working oil from the tank to the regeneration passage 52 is provided.

In the supply and discharge passage 30 connecting the piston side chamber 31a of the boom cylinder 31 and the operation valve 14, an electromagnetic proportional throttle valve 34 whose opening degree is controlled by an output signal of the controller 50 is provided. The electromagnetic proportional throttle valve 34 is maintained at a full open position in a normal state.

The regeneration passage 52 branching from a part between the piston side chamber 31a and the electromagnetic proportional throttle valve 34 is connected to the supply and discharge passage 30. The regeneration passage 52 is a passage for guiding the return working oil from the piston side chamber 31a to the regeneration motor 46.

In the regeneration passage 52, a switching valve 53 serving as a switching valve for regeneration to be controlled and switched by a signal outputted from the controller 50 is provided.

When a solenoid is not excited, the switching valve 53 is switched to a closed position (state shown in FIG. 1) to block the regeneration passage 52. When the solenoid is excited, the switching valve 53 is switched to an opened position to let the regeneration passage 52 communicate. The switching valve 53 blocks the working oil guided from the piston side chamber 31a to the regeneration motor 46 at the time of failure of the regeneration unit 45. Therefore, at the time of failure of the regeneration unit 45, since the working oil is not guided to the regeneration unit 45, the hybrid construction machine can be activated as a normal hydraulic excavator.

In the operation valve 14, a sensor 14a configured to detect the operating direction and an operation amount of the operation valve 14 is provided. A signal of pressure detected by the sensor 14a is outputted to the controller 50. Detection of the operating direction and the operation amount of the operation valve 14 is equal to detection of the extending/stowing direction and extending/stowing speed of the boom cylinder 31. Therefore, the sensor 14a functions as an action state detector configured to detect an action state of the boom cylinder 31.

It should be noted that instead of the sensor 14a, a sensor configured to detect the moving direction and a moving amount of a piston rod may be provided in the boom cylinder 31 as an action state detector. Alternatively, a sensor configured to detect the operating direction and an operation amount of the operation lever 55 may be provided in the operation lever 55.

The controller 50 judges whether the operator intends to extend or stow the boom cylinder 31 on the basis of a detection result of the sensor 14a. When the controller 50 judges an extending action of the boom cylinder 31, the controller maintains the electromagnetic proportional throttle valve 34 at a full open position in a normal state and maintains the switching valve 53 at a closed position.

Meanwhile, when the controller 50 judges a stowing action of the boom cylinder 31, the controller calculates the stowing speed of the boom cylinder 31 demanded by the operator in accordance with the operation amount of the operation valve 14, adjusts the opening degree of the electromagnetic proportional throttle valve 34 to a small value, and switches the switching valve 53 to an opened position. Thereby, part or all of the return working oil from the boom cylinder 31 is guided to the regeneration motor 46, and boom regeneration is performed.

Next, an assist pump 47 configured to assist outputs of the first and second main pumps 26 and 27 will be described.

The assist pump 47 is a variable capacity type pump in which a tilting angle can be adjusted and being coupled to be rotated coaxially to the regeneration motor 46. The assist pump 47 is rotated by regeneration drive force of the regeneration unit 45 and drive force of the electric motor 48. The rotation number of the electric motor 48 is controlled by the controller 50 through the inverter 49. The tilting angles of the swash plates of the assist pump 47 and the regeneration motor 46 are controlled by the controller 50 via regulators 35 and 36.

A discharge passage 37 serving as an assist passage is connected to the assist pump 47. The assist pump 47 can supply the working oil to the neutral passages 6 and 16 via the discharge passage 37. The discharge passage 37 is formed to be divided into a first assist passage 38 joining the discharge side of the first main pump 26 and a second assist passage 39 joining the discharge side of the second main pump 27.

First and second electromagnetic proportional throttle valves 40 and 41 serving as variable throttles whose opening degrees are controlled by output signals from the controller 50 are respectively provided in the first and second assist passages 38 and 39. The first and second electromagnetic proportional throttle valves 40 and 41 serving as variable throttles correspond to load adjusting units. The first and second electromagnetic proportional throttle valves 40 and 41 change a load of the assist pump 47 in accordance with a state of the battery 24. That is, by adjusting the opening degrees of the first and second electromagnetic proportional throttle valves 40 and 41 to small values, the load of the assist pump 47 can be increased.

Check valves 42 and 43 configured to allow only flows of the working oil from the assist pump 47 to the first and second main pumps 26 and 27 are respectively provided in the first and second assist passages 38 and 39 on the downstream of the first and second electromagnetic proportional throttle valves 40 and 41.

When the assist pump 47 is rotated by the drive force of the electric motor 48, the assist pump 47 assists the first and second main pumps 26 and 27. The controller 50 controls the opening degrees of the first and second electromagnetic proportional throttle valves 40 and 41 in accordance with the pressure signals from the first and second pressure sensors 11 and 21, and proportionally divides and supplies the working oil discharged from the assist pump 47 to the discharge side of the first and second main pumps 26 and 27.

When the working oil is supplied to the regeneration motor 46 through the regeneration passage 52, rotation force of the regeneration motor 46 acts as assist force to the coaxially rotating electric motor 48. Therefore, for the amount of the rotation force of the regeneration motor 46, electric power consumption of the electric motor 48 can be reduced.

In a case where the electric motor 48 is used as a power generator with the regeneration motor 46 as a drive source and there is no need for assist, and when the battery 24 is in a proper state, the tilting angle of the assist pump 47 is set to be zero and the assist pump 47 is brought into a substantially no load state. Meanwhile, in a case where the battery 24 is not in a proper state, the load of the assist pump 47 is increased. Control of this load of the assist pump 47 will be described in detail later.

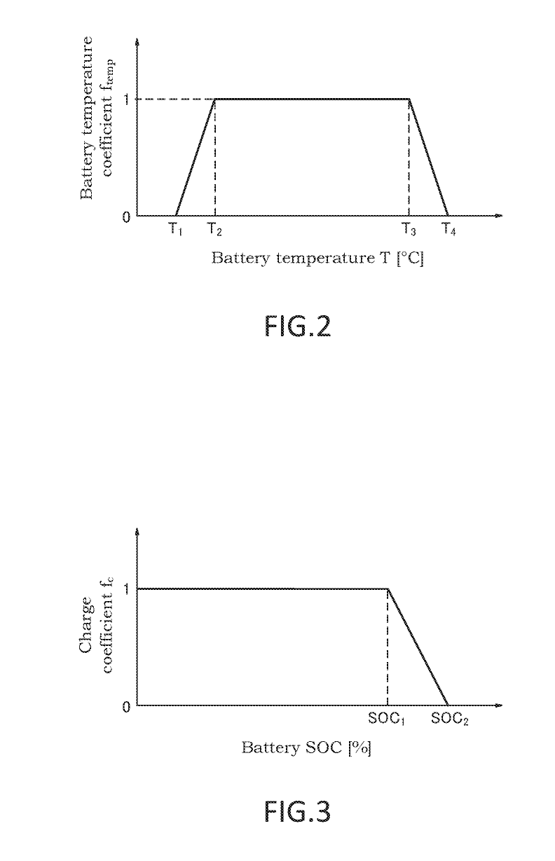

Next, mainly with reference to FIGS. 2 and 3, the regeneration control in the control system 100 of the hybrid construction machine will be described.

In a map shown in FIG. 2, the horizontal axis indicates a temperature T[° C.] of the battery 24, and the vertical axis indicates a battery temperature coefficient fₜₑₘₚ. The battery temperature coefficient fₜₑₘₚ is a coefficient whose maximum value is set to be one.

Regarding the battery 24, in a case where the temperature is lower and higher than a proper temperature range, a charge performance is lowered. A range from not less than T₂[° C.] and not more than T₃[° C.] is the proper temperature range. Therefore, in a case where the temperature T of the battery 24 is lower than T₂[° C.], the battery temperature coefficient fₜₑₘₚ is set to be smaller as the temperature is lowered toward T₁[° C.]. The battery temperature coefficient fₜₑₘₚ becomes zero when the temperature T of the battery 24 becomes T₁[° C.].

Similarly, in a case where the temperature T of the battery 24 is higher than T₃[° C.], the battery temperature coefficient fₜₑₘₚ is set to be smaller as the temperature is increased toward T₄[° C.]. The battery temperature coefficient fₜₑₘₚ becomes zero when the temperature T of the battery 24 becomes T₄[° C.].

Meanwhile, in a map shown in FIG. 3, the horizontal axis indicates the SOC[%] of the battery 24, and the vertical axis indicates a charge coefficient f_{c}. The charge coefficient f_{c} is a coefficient whose maximum value is set to be one.

Regarding the battery 24, in a case where the SOC is higher than a proper range, there is a need for lowering a charge amount in order to prevent overcharge. The maximum value of the SOC chargeable in the battery 24 is SOC₂[%]. Therefore, in a case where the SOC of the battery 24 is higher than SOC₁[%] set to be lower than SOC₂[%], the charge coefficient f_{c} is set to be smaller as the SOC is increased toward SOC₂[%]. The charge coefficient f_{c} becomes zero when the SOC of the battery 24 becomes SOC₂[%].

When the controller 50 judges that the boom cylinder 31 is performing the stowing action on the basis of the detection result of the sensor 14a, the controller adjusts the opening degree of the electromagnetic proportional throttle valve 34 to a small value, and switches the switching valve 53 to an opened position. Thereby, at the time of stowing the boom cylinder 31, the return working oil from the piston side chamber 31a is guided to the regeneration motor 46, and the regeneration control of the boom regeneration is started.

Firstly, an electric signal in accordance with the temperature of the battery 24 and an electric signal in accordance with the SOC of the battery 24 are inputted to the controller 50 from the battery 24. The controller 50 obtains the battery temperature coefficient fₜₑₘₚ corresponding to the temperature of the battery 24 from the map of FIG. 2, and obtains the charge coefficient f_{c} corresponding to the SOC of the battery 24 from the map of FIG. 3.

Regeneration power inputted to the regeneration motor 46 is Lᵣₘ [W], charge power generated by the electric motor 48 is Lₑₘ [W], and assist pump drive power to drive the assist pump 47 is Lₐₚ [W]. A relationship of these is: “regeneration power Lᵣₘ [W]^{”}=“charge power Lₑₘ [W]”+“assist pump drive power Lₐₚ [W]”.

When the working oil is discharged from the piston side chamber 31a at the time of lowering the boom and stowing the boom cylinder 31, the controller 50 calculates power of the electric motor 48 corresponding to a power generation amount chargeable in the battery 24 on the basis of the state of the battery 24 with “charge power Lₑₘ [W]”×“battery temperature coefficient fₜₑₘₚ”×“charge coefficient f_{c}”. The controller 50 calculates the assist pump drive power Lₐₚ [W] from “assist pump drive power Lₐₚ [W]”=“regeneration power Lᵣₘ [W]”−“charge power Lₑₘ [W]”×“battery temperature coefficient fₜₑₘₚ”×“charge coefficient f_{c}”.

In a case where both the temperature and the SOC of the battery 24 are in a proper state, “battery temperature coefficient fₜₑₘₚ”=1 and “charge coefficient f_{c}”=1 from FIGS. 2 and 3, which leads to “assist pump drive power Lₐₚ [W]”=“regeneration power Lᵣₘ [W]”−“charge power Lₑₘ [W]”.

At the time of stowing the boom separately, the tilting angle of the swash plate of the assist pump 47 is set to be zero and the assist pump is brought into a substantially no load state. Therefore, the assist pump drive power Lₐₚ [W] is zero, with “charge power Lₑₘ [W]”=“regeneration power Lᵣₘ [W]”. Thus, all the power by the working oil guided to the regeneration motor 46 is charged in the battery 24 by power generation of the electric motor 48.

Meanwhile, in a case where the temperature or the SOC of the battery 24 is no more in a proper range, “battery temperature coefficient fₜₑₘₚ”<1 or “charge coefficient f_{c}”<1 from FIGS. 2 and 3. Therefore, from “assist pump drive power Lₐₚ [W]”=“regeneration power Lᵣₘ [W]”−“charge power Lₑₘ [W]”×“battery temperature coefficient fₜₑₘₚ”×“charge coefficient f_{c}”, the assist pump drive power Lₐₚ [W] is increased.

At this time, the tilting angle of the swash plate of the assist pump 47 is set to be increased, and the opening degrees of the first and second electromagnetic proportional throttle valves 40 and 41 are adjusted to small values. That is, the load of the assist pump 47 is increased. Therefore, part of the power by the working oil guided to the regeneration motor 46 is consumed by drive of the assist pump 47. Thus, the power to be charged in the battery 24 by the power generation of the electric motor 48 is reduced.

In a case where the temperature T of the battery 24 becomes not more than T₁[° C.] or not less than T₄[° C.], or in a case where the SOC of the battery 24 becomes not less than SOC₂[%], “battery temperature coefficient fₜₑₘₚ”=0 or “charge coefficient f_{c}”=0 from FIGS. 2 and 3. Therefore, from “assist pump drive power Lₐₚ [W]^{”}=“regeneration power Lᵣₘ [W]”, all the regenerated power becomes the assist pump drive power Lₐₚ [W].

At this time, in order to ensure a discharge flow rate of the assist pump 47 and ensure discharge pressure of the assist pump 47 by adjusting the tilting angle of the swash plate and the rotation number in such a manner that all the power by the working oil guided to the regeneration motor 46 is consumed by the drive of the assist pump 47, the opening degrees of the first and second electromagnetic proportional throttle valves 40 and 41 are adjusted.

In such a way, the load of the assist pump 47 is set to be increased in a case where the temperature of the battery 24 is higher or lower than the preliminarily regulated proper range more than a case where the temperature is in the proper range, and set to be increased in a case where the SOC of the battery 24 is higher than the preliminarily regulated proper range more than a case where the SOC is in the proper range.

In a case where the temperature of the battery 24 is higher or lower than the preliminarily regulated proper range and in a case where the SOC of the battery 24 is higher than the preliminarily regulated proper range, the controller 50 increases the tilting angle of the swash plate of the assist pump 47, and decreases the opening degrees of the first and second electromagnetic proportional throttle valves 40 and 41, to increase the load of the assist pump 47. Therefore, the power by the working oil discharged from the piston side chamber 31a of the boom cylinder 31 is consumed by the assist pump 47 more for the increased amount of the load. Thus, since a power generation amount by the electric motor 48 is reduced in comparison to a state where the load of the assist pump 47 is not increased, an amount of charging in the battery 24 is also reduced. Therefore, a normal operation can be performed irrespective of the state of the battery 24.

At the time of lowering the boom and the stowing the boom cylinder 31, adjustment can be made in such a manner that the power generated by rotating the electric motor 48 by the working oil discharged from the piston side chamber 31a and guided to the regeneration motor 46 does not exceed a storage amount of the battery 24. Therefore, in a case where the power chargeable in the battery 24 is reduced, by increasing the power consumable by the assist pump 47, the power by the working oil guided to the regeneration motor 46 can be consumed. Thus, since the power by the working oil guided to the regeneration motor 46 is prevented from being not consumed and left, a change in working speed of the boom cylinder 31 can be suppressed.

Thereby, since lowering speed of the boom is not changed by the temperature and the SOC of the battery 24, a feeling of strangeness at the time of operation can be eliminated. There is no need for, in order to prevent lowering of the working speed of the boom cylinder 31, preliminarily increasing the opening degree of the electromagnetic proportional throttle valve 34, setting a bleed flow rate to rather high, and reducing the regeneration power, to correspond to a change in the charge power of the battery 24. Thus, an energy saving performance can be improved.

In general, in a case where the hydraulic excavator to which the control system 100 of the hybrid construction machine is applied is large-sized, there is a need for applying an electric motor 48 having a large rating capacity. Meanwhile, in a case where the load of the assist pump 47 is increased on the basis of the SOC of the electric motor 48, the same electric motor 48 can be applied irrespective of size of the hydraulic excavator. Therefore, by a mass production effect by sharing of the electric motor 48, cost can be reduced.

According to the above embodiment, the following effects are exerted.

The first and second electromagnetic proportional throttle valves 40 and 41 change the load of the assist pump 47 in accordance with the state of the battery 24. Therefore, in a case where the battery 24 is not in a proper state, the load of the assist pump 47 can be increased. In this case, the power by the working oil discharged from the piston side chamber 31a of the boom cylinder 31 is consumed by the assist pump 47 more for the increased amount of the load. Thus, since the power generation amount by the electric motor 48 is reduced in comparison to a state where the load of the assist pump 47 is not increased, the amount of charging in the battery 24 is also reduced. Therefore, a normal operation can be performed irrespective of the state of the battery 24.

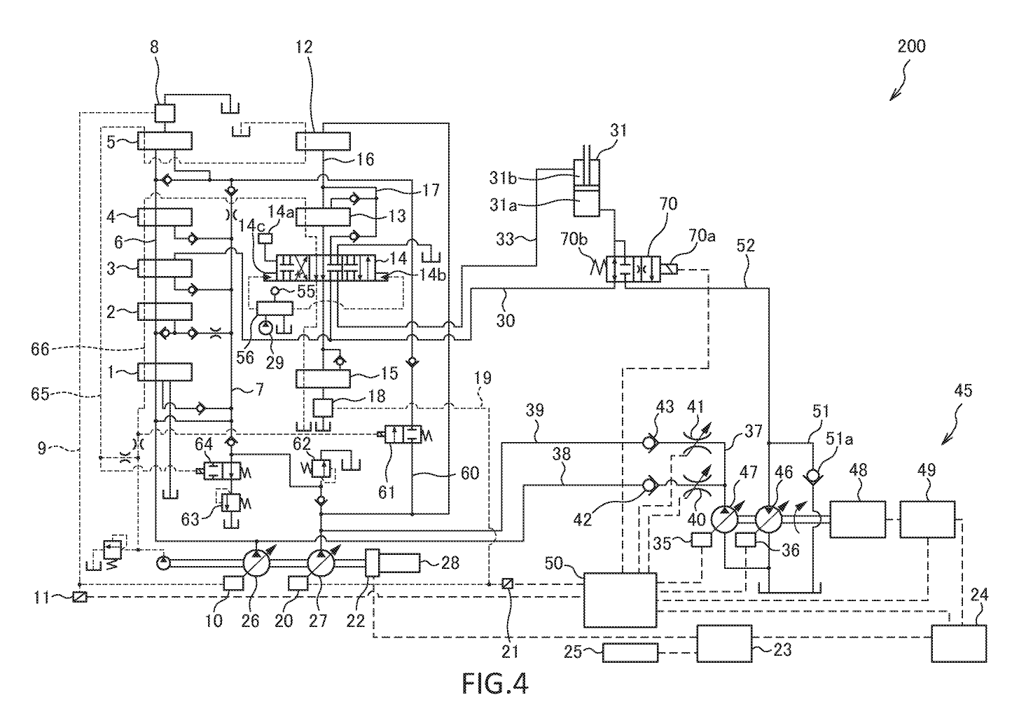

Hereinafter, with reference to FIG. 4, a control system 200 of a hybrid construction machine according to a modified example of the embodiment of the present invention will be described. Hereinafter, points different from the above embodiment will be mainly described, and configuration having the same functions will be given the same reference signs and description thereof will be omitted.

The control system 200 of the hybrid construction machine is different from the above embodiment in a point where the electromagnetic proportional throttle valve 34 and the switching valve 53 are provided as a single valve.

The control system 200 of the hybrid construction machine includes a boom regeneration valve 70 serving as a regeneration control valve configured to control a flow rate of working oil guided from a piston side chamber 31a to a regeneration motor 46 and a bleed flow rate of the bled working oil at the time of stowing a boom cylinder 31.

The boom regeneration valve 70 has functions as the electromagnetic proportional throttle valve 34 and the switching valve 53 in the above embodiment, and is switched by a single control signal from a controller 50. When a solenoid 70a is not excited, the boom regeneration valve 70 is switched by bias force of a return spring 70b in such a manner that all the working oil discharged from the piston side chamber 31a is bled (state shown in FIG. 4). This state corresponds to a state where the switching valve 53 is switched to a closed position and an opening degree of the electromagnetic proportional throttle valve 34 is adjusted to a maximum value in the first embodiment.

Meanwhile, when the solenoid 70a is excited, the boom regeneration valve 70 is switched in such a manner that part of the working oil discharged from the piston side chamber 31a is guided to the regeneration motor 46 and the bleed flow rate is decreased for the guided amount. This state corresponds to a state where the switching valve 53 is switched to an opened position and the opening degree of the electromagnetic proportional throttle valve 34 is adjusted to a small value in the first embodiment.

In the above modified example, in a case where a battery 24 is not in a proper state, a load of an assist pump 47 is increased as well as the above embodiment. Therefore, power by the working oil discharged from the piston side chamber 31a of the boom cylinder 31 is consumed by the assist pump 47 more for the increased amount of the load. Thus, since a power generation amount by an electric motor 48 is reduced in comparison to a state where the load of the assist pump 47 is not increased, an amount of charging in the battery 24 is also reduced. However, power by the working oil guided to the regeneration motor 46 is unchanged. Therefore, a normal operation can be performed irrespective of a state of the battery 24.

The boom regeneration valve 70 has the functions as the electromagnetic proportional throttle valve 34 and the switching valve 53, and is switched by a single control signal from the controller 50. Therefore, in comparison to a case where the electromagnetic proportional throttle valve 34 and the switching valve 53 are switched by separate control signals, regeneration control can be more easily executed.

Configurations, operations, and effects of the embodiment of the present invention will be summarized below.

The control system 100 and 200 of the hybrid construction machine is characterized by including the first and second main pumps 26 and 27 configured to supply the working oil to the boom cylinder 31, the regeneration motor 46 to be rotated by the working oil discharged from the piston side chamber 31a of the boom cylinder 31, the electric motor 48 coupled to the regeneration motor 46, the battery 24 configured to store the electric power generated by the electric motor 48, the assist pump 47 provided coaxially to the regeneration motor 46 to be driven by the electric motor 48, the assist pump 47 being configured to supply the working oil to the actuators, and the load adjusting units (first and second electromagnetic proportional throttle valves 40 and 41) configured to change the load of the assist pump 47 in accordance with the state of the battery 24.

With this configuration, the load adjusting units (first and second electromagnetic proportional throttle valves 40 and 41) change the load of the assist pump 47 in accordance with the state of the battery 24. Therefore, in a case where the battery 24 is not in a proper state, the load of the assist pump 47 can be increased. In this case, the power by the working oil discharged from the piston side chamber 31a of the boom cylinder 31 is consumed by the assist pump 47 more for the increased amount of the load. Thus, since the power generation amount by the electric motor 48 is reduced in comparison to a state where the load of the assist pump 47 is not increased, the amount of charging in the battery 24 is also reduced. However, the power by the working oil guided to the regeneration motor 46 is unchanged. Therefore, a normal operation can be performed irrespective of the state of the battery 24.

The control system is characterized in that the state of the battery 24 is the temperature of the battery 24, and the load adjusting units (first and second electromagnetic proportional throttle valves 40 and 41) increase the load of the assist pump 47 in a case where the temperature of the battery 24 is higher or lower than the preliminarily regulated proper range more than a case where the temperature of the battery 24 is in the proper range.

The control system is characterized in that the state of the battery 24 is the SOC of the battery 24, and the load adjusting units (first and second electromagnetic proportional throttle valves 40 and 41) increase the load of the assist pump 47 in a case where the SOC of the battery 24 is higher than the preliminarily regulated proper range more than a case where the SOC of the battery 24 is in the proper range.

With these configurations, the load of the assist pump 47 is increased on the basis of at least any one of the temperature and the SOC of the battery 24. Therefore, in a case where the temperature of the battery 24 or the SOC of the battery 24 is not in the proper range, the power generation amount by the electric motor 48 is reduced for the increased amount of the load of the assist pump 47. Since the amount of charging in the battery 24 is reduced, the battery 24 can be protected.

The control system is characterized in that the load adjusting units are the first and second electromagnetic proportional throttle valves 40 and 41 provided in the discharge passage 37 configured to guide the working oil discharged from the assist pump 47 so as to the working oil is supplied to the actuators, and the load of the assist pump 47 is increased by adjusting the opening degrees of the first and second electromagnetic proportional throttle valves 40 and 41 to small values.

With this configuration, by adjusting the opening degrees of the first and second electromagnetic proportional throttle valves 40 and 41 to small values, even in a case where the pressure of the working oil supplied from the first and second main pumps 26 and 27 to the actuators is low, the pressure of the working oil in the discharge passage 37 can be boosted. Therefore, irrespective of the pressure of the working oil supplied from the first and second main pumps 26 and 27 to the actuators, the load of the assist pump 47 can be increased.

Embodiments of the present invention were described above, but the above embodiments are merely examples of applications of the present invention, and the technical scope of the present invention is not limited to the specific constitutions of the above embodiments.

For example, in the above embodiment, various coefficients are determined by using the maps shown in FIGS. 2 and 3. However, the present invention is not limited to this but various coefficients may be determined by functions.

In the above embodiment, the load of the assist pump 47 is changed by using the first and second electromagnetic proportional throttle valves 40 and 41 serving as variable throttles. However, instead of this, variable relief valves may be used. The load of the assist pump 47 may be changed only by controlling the tilting angle of the swash plate of the assist pump 47.

With respect to the above description, the contents of application No. 2014-237328, with a filing date of Nov. 25, 2014 in Japan, are incorporated herein by reference.

1. A control system of a hybrid construction machine, comprising:
a fluid pressure pump configured to supply a working fluid to a fluid pressure actuator;
a regeneration motor configured to be rotated by the working fluid discharged from a load side pressure chamber of the fluid pressure actuator;
a rotating electric motor coupled to the regeneration motor;
a storage battery configured to store electric power generated by the rotating electric motor;
an assist pump provided coaxially to the regeneration motor to be driven by the rotating electric motor, the assist pump being configured to supply the working fluid to the fluid pressure actuator; and
a load adjusting unit configured to change a load of the assist pump in accordance with a state of the storage battery.

2. The control system of the hybrid construction machine according to claim 1, wherein
the state of the storage battery is a temperature of the storage battery, and
the load adjusting unit increases the load of the assist pump in a case where the temperature of the storage battery is higher or lower than a preliminarily regulated proper range more than a case where the temperature of the storage battery is in the proper range.

3. The control system of the hybrid construction machine according to claim 1, wherein
the state of the storage battery is a SOC of the storage battery, and
the load adjusting unit increases the load of the assist pump in a case where the SOC of the storage battery is higher than a preliminarily regulated proper range more than a case where the SOC of the storage battery is in the proper range.

4. The control system of the hybrid construction machine according to claim 1, wherein
the load adjusting unit is a variable throttle provided in an assist passage, the assist passage being configured to guide the working fluid discharged from the assist pump so as to the working fluid is supplied to the fluid pressure actuator, and
the load of the assist pump is increased by adjusting an opening degree of the variable throttle to a small value.
